(19) United States
(12) Patent Application Publication
(10) Pub. No.: US 2008/0245721 A1
(43) Pub. Date: Oct. 9, 2008

(54) FLUID FILTER

(75) Inventors: Tasuku ASAHINA, Hamamatsu-shi (JP); Masanori GOTO, Hamamatsu-shi (JP); Hirokazu SUZUKI, Hamamatsu-shi (JP)

Correspondence Address: YOUNG & THOMPSON, 209 Madison Street, Suite 500, ALEXANDRIA, VA, 22314, US

(73) Assignee: TOYO ROKI SEIZO KABUSHIKI KAISHA, Hamamatsu-shi (JP)

(21) Appl. No.: 12/061,684

(22) Filed: Apr. 3, 2008

(30) Foreign Application Priority Data
Apr. 3, 2007 (JP) 2007-097051

(51) Int. Cl. F02M 37/22

(52) U.S. Cl. 210/248

(57) ABSTRACT

A filter media is for fluid to pass therethough. A filter element includes a holding member for holding the filter media. A filter case houses the filter element, having a fluid inlet positioned on a side relative to the filter element, and having a fluid outlet positioned on another side relative to the filter element. A support member extends between the holding member and the filter case. The support member is opposed to one member of the filter case and the holding member with a space between the support member and said one member.

### CROSS-REFERENCE TO RELATED APPLICATIONS

This application is based upon and claims the benefit of priority from Japanese Patent Application No. 2007-097051 filed on Apr. 3, 2007; the entire contents of which are incorporated herein by reference.

### BACKGROUND OF THE INVENTION

The invention relates to a fluid filter applicable to, for example, an automatic transmission.

A related oil filter includes a filter case housing a filter media and having a combination of two split pieces, ribs holding the filter media to the filter case, and protrusions extending from the filter case and contacting the ribs (Refer to Patent Document 1).

Oil flows into the filter case from the inlet, passing through the filter media, and flows out from an outlet of the filter case.

Patent Document 1: Japanese Patent Application Laid-open No. 2004-353783

When a negative pressure is caused in the filter case, the filter case tends to be deformed inwardly. The protrusions support the filter case, preventing the deformation of the filter case.

On the other hand, while the split pieces of the filter case are subjected to vibration-welding, the protrusions and the filter case become worn by friction of each other, thus causing a foreign matter (burr).

### SUMMARY OF THE INVENTION

The invention is directed to a fluid filter capable of supporting the filter case and preventing the cause of a foreign matter.

An aspect of the invention provides a fluid filter including the following components. The filter includes a filter media for fluid to pass therethough. The filter includes a filter element including a holding member for holding the filter media. The filter includes a filter case housing the filter element, having a fluid inlet positioned on a side relative to the filter element, and having a fluid outlet positioned on another side relative to the filter element. The filter includes a support member extending between the holding member and the filter case. The support member is opposed to one member of the filter case and the holding member with a space between the support member and said one member.

The support member may extend from the filter case toward the holding member.

The support member may extend from the holding member toward the filter case.

According to the features of the invention, fluid flows into the filter case from the fluid inlet, passing through the filter media, flowing out outside of the filter case from the fluid outlet.

In addition, the flow velocity of the fluid increases, and when a negative pressure is caused in the filter case, the filter case tends to be deformed inwardly. The support member abuts against one member of the holding member and the filter case to support the filter case.

During the welding of the filter case, the support member are opposed to one member of the holding member and the filter case with a space between the support member and said one member, which are free from friction of each other and prevents the cause of a foreign matter.

### BRIEF DESCRIPTION OF THE ACCOMPANYING DRAWINGS

FIG. 1A is a perspective view of an oil filter according to a first embodiment;

FIG. 1B is a side view of the oil filter;

FIG. 2A is an exploded upper perspective view of the oil filter illustrated in FIGS. 1A and 1B;

FIG. 2B is an exploded lower perspective view of oil the filter;

FIG. 3A is a broken-off sectional view of the oil filter illustrated in FIGS. 1A and 1B;

FIG. 3B is a broken-off perspective view of the oil filter;

FIG. 4A is an exploded upper perspective view of an oil filter according to a second embodiment;

FIG. 4B is an exploded lower perspective view of the filter;

FIG. 5A is a broken-off sectional view of the oil filter illustrated in FIGS. 4A and 4B;

FIG. 5B is a broken-off perspective view of the oil filter;

FIG. 6A is an exploded upper perspective view of an oil filter according to a third embodiment;

FIG. 6B is an exploded lower perspective view of the oil filter;

FIG. 7A is a broken-off sectional view of the oil filter illustrated in FIGS. 6A and 6B;

FIG. 7B is a broken-off perspective view of the oil filter;

FIG. 8A is an exploded upper perspective view of an oil filter according to a fourth embodiment;

FIG. 8B is an exploded lower perspective view of the oil filter;

FIG. 9A is a broken-off sectional view of the oil filter illustrated in FIGS. 8A and 8B;

FIG. 9B is a broken-off perspective view of the filter;

FIG. 10A is an exploded upper perspective view of an oil filter according to a fifth embodiment;

FIG. 10B is an exploded lower perspective view of the oil filter;

FIG. 11A is a broken-off sectional view of the oil filter illustrated in FIGS. 10A and 10B;

FIG. 11B is a broken-off perspective view of the oil filter;

FIG. 12A is an exploded upper perspective view of the oil filter according to a sixth embodiment;

FIG. 12B is an exploded lower perspective view of the oil filter;

FIG. 13A is a broken-off sectional view of the oil filter illustrated in FIGS. 12A and 12B;

FIG. 13B is a broken-off perspective view of the oil filter;

FIG. 14A is an exploded upper perspective view of an oil filter according to a seventh embodiment;

FIG. 14B is an exploded lower perspective view of the filter;

FIG. 15A is a broken-off sectional view of the oil filter illustrated in FIGS. 14A and 14B;

FIG. 15B is a broken-off perspective view of the oil filter;

FIG. 16A is an exploded perspective view of an oil filter according to an eighth embodiment;

FIG. 16B is an exploded lower perspective view of the oil filter;

FIG. 17A is a broken-off sectional view of the oil filter illustrated in FIGS. 16A and 16B; and

FIG. 17B is a broken-off perspective view of the oil filter.

### DETAILED DESCRIPTION OF THE EMBODIMENTS

Embodiments of the invention will be described below with reference to the accompanying drawings.

### First Embodiment

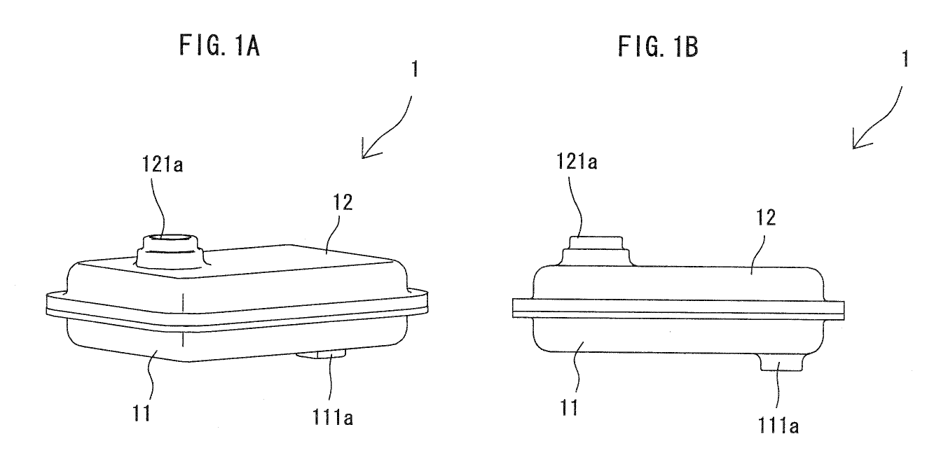

With reference to FIGS. 1A and 1B, an oil filter 1 includes a case 11 as a filter case, a cover 12 as a filter case joined to the case 11, and a filter element 13 located between the case 11 and the cover 12. The oil filter 1 has a longitudinal direction (extending direction of a rib 133), a transverse direction normal to the longitudinal direction, and a transverse position in the transverse direction.

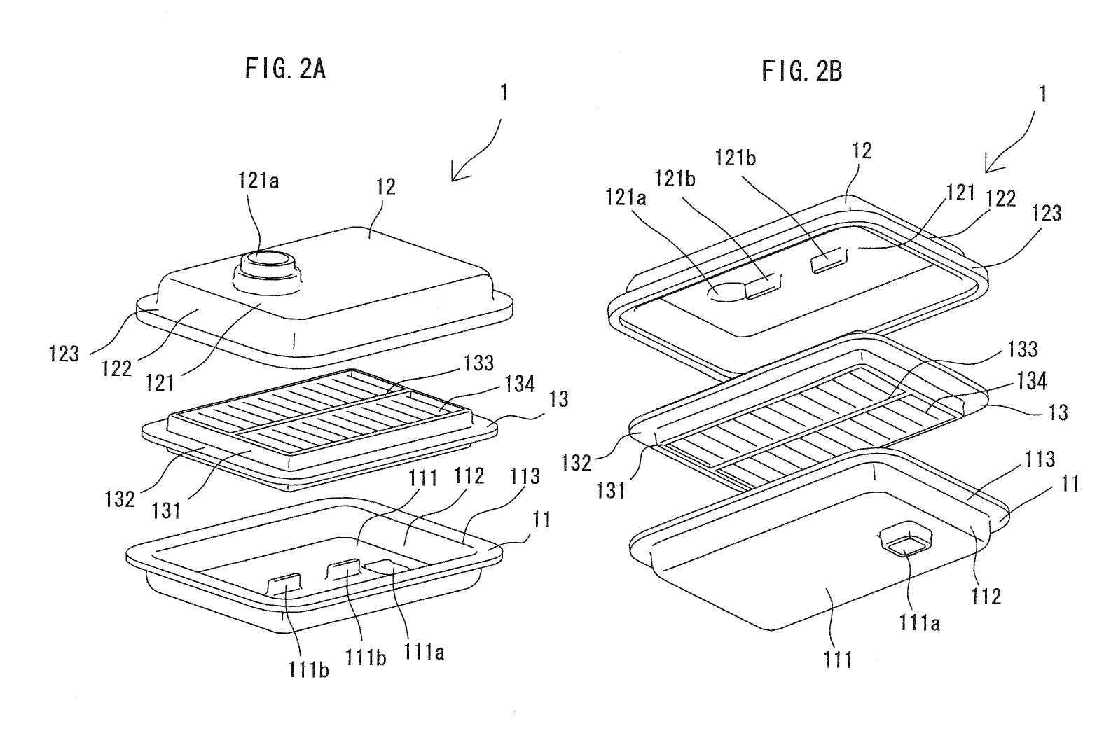

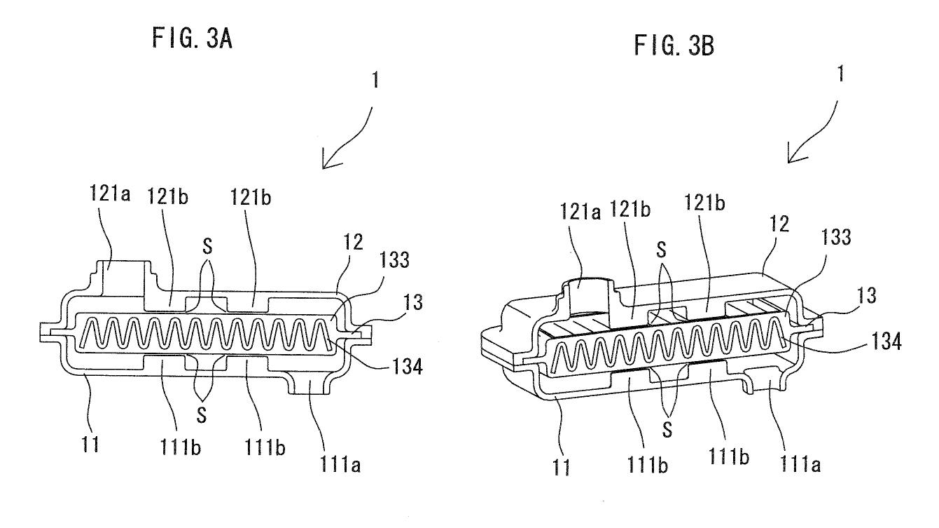

FIGS. 2A, 2B, 3A and 3B, the rectangular case 11 includes a bottom wall 111, a side wall 112 extending upward from the outer circumference of the bottom wall 111, and a flange 113 extending outward from the end of the side wall 112. The bottom wall 111 has an inlet 111a for taking oil in. The bottom wall 111 has a rectangular support walls 111b as support members longitudinally aligned with each other.

The cover 12 includes a top wall 121, a side wall 122 extending downward from the top wall 121, and a flange 123 extending outward from the end of the side wall 122. The top wall 121 has an inlet 121a on the right side. The top wall 121 has rectangular support walls 121b as support members longitudinally aligned with each other. The support walls 121b extends downward from the reverse side of the top wall 121.

The filter element 13 includes an outer frame 131, a flange 132 extending outward from the outer frame 131, a rib 133 as a holding member longitudinally extending so as to cross the outer frame 132. The filter element 13 includes a filter media 134 housed in the outer frame 132 and held by the rib 133. The flange 132 is interposed between the flange 113 of the case 11 and the flange 123 of the cover 12. The filter media 134 is, for example, a filtering felt or a sheet such as a filter paper. This sheet is folded into a wave-shape.

Here, the support walls 111b, 121b, and the rib 133 are arranged in plane view on the straight line connecting the inlet 111a and the outlet 121a. Accordingly, the support walls 111b are coincident with the rib 133 with regard to the transverse positions. The support walls 111b are opposed to the rib 133 with spaces S between them 111b, 133. The support walls 121b are coincident with the rib 133 with regard to the transverse positions. The support walls 121b are opposed to the rib 133 with spaces S between them 121b, 133.

Next, a method of joining the case 11 and the cover 12 is described.

With reference to FIGS. 2A and 2B, the flange 113 of the case 11 and the flange 123 of the cover 12 are fitted with each other with the filer element 13 placed between them 113, 123. The flanges 113, 123 are vibrated and slid thereby being welded together. The support walls 111b, 121b are opposed to the rib 133 with the spaces S between them, so that the support walls 111b, 121b and the rib 133 are free from friction of each other, preventing the cause of a foreign matter. Instead of the vibration welding, supersonic welding or heat welding may be applied.

Next, an operation of the oil filter 1 is described.

For example, oil flows out of an automobile transmission to be taken into the case 11 through the inlet 111a. The oil flows into a dust side of the filter media 134 in the case 11 and passes through the filter media 134. The filter media 134 catches a foreign matter included in the oil to remove the foreign matter from the oil. The oil passes through a clean side of the filter media 134 to flow into the cover 12. The oil flows out from the inlet 121a to return to the automatic transmission.

The support walls 111b, 121b guide the oil longitudinally from the inlet 111a to the outlet 121a. The spaces S between the support wall 111b, 121b and the rib 133 permit passing of the oil through them S and ensuring the flow passage of the oil so that a flow performance of the case 11 and the cover 12 are enhanced.

When the flow velocity of the oil increases and a negative pressure is caused inside of the case 11 and the cover 12, the bottom 111 of the case 11 and the top wall 121 of the cover 12 become deformed and curved inwardly. The support walls 111b, 121b abut against the rib 133 to support the bottom wall 111 of the case 11 and the top wall 121 of the cover 12, respectively.

### Second Embodiment

Hereafter, the similar reference characters are assigned to the similar components, and the descriptions are omitted.

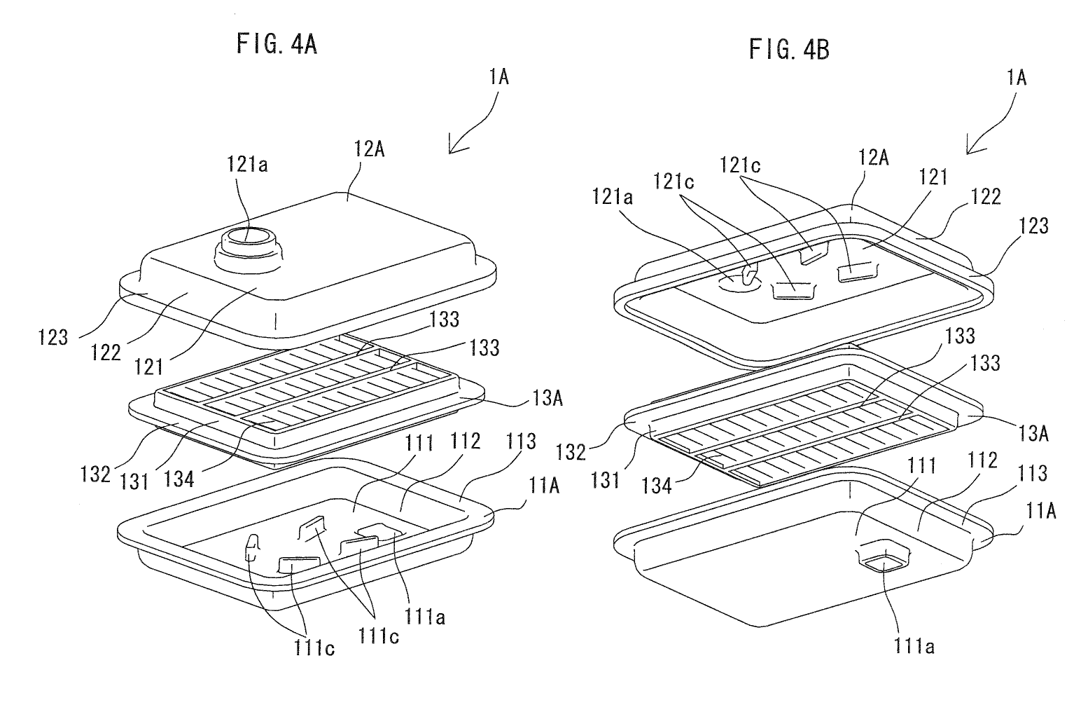

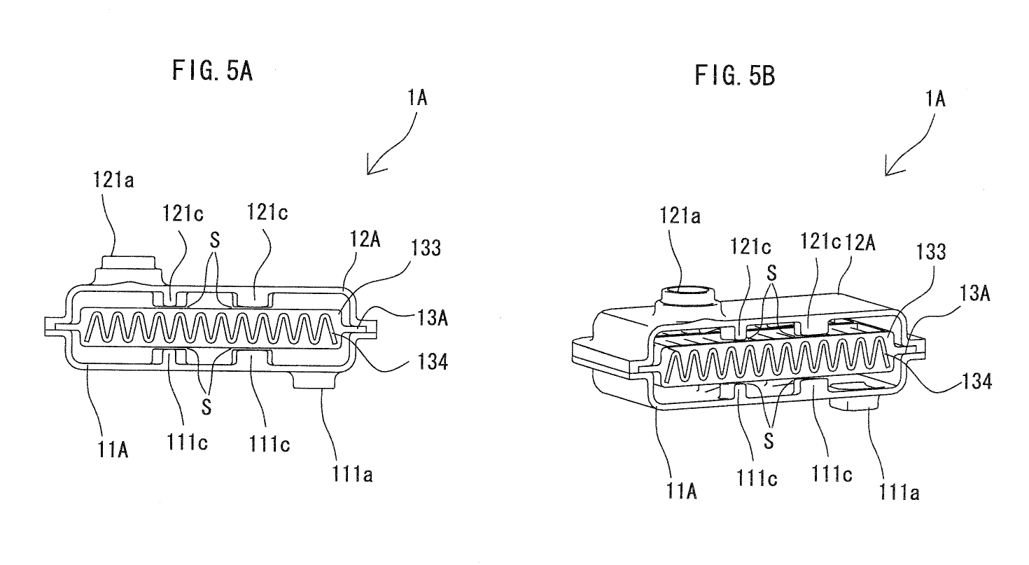

With reference to FIGS. 4A, 4B, 5A, and 5B, an oil filter 1A is described.

A case 11A includes support walls 111c as support members extending in plane view obliquely to the straight line connecting the inlet 111a and the outlet 121a or ribs 133.

A cover 12A includes support walls 121c as support members extending in plane view obliquely to the straight line connecting the inlet 111a and the outlet 121a or the ribs 133. A pair of support walls 121c located in the transverse direction comes closer to each other from the inlet 111a toward the outlet 112a.

A filer element 13A includes the ribs 133 extending longitudinally in two rows. The ribs 133 and the support walls 111c are coincident with each other with regard to in the transverse positions. The ribs 133 and the support walls 121c are coincident with each other with regard to in the transverse positions.

The support walls 111c are off from the ribs 133 to be opposed to the ribs 133 with spaces S between them 111c, 133. The support walls 121c are off from the ribs 133 to be opposed to the ribs 133 with spaces S between them 121c, 133.

According to the above-described oil filter 1A, when the case 11A and the cover 12A are welded together, the support walls 111c, 121c are opposed to the ribs 133 with the spaces S between them, which prevents a foreign matter from being caused during the welding.

The spaces S permit passing of the oil through them S, ensuring a flow passage of the oil.

When a negative pressure is caused in the case, the support wall 111c, 121c abut against the ribs 133 so as to support the bottom wall 111 of the case 11A and the top wall 121 of the cover 12A, respectively.

The support walls 111c, 121c guide the oil obliquely to the straight line connecting the inlet 111a and the outlet 121a in plane view or the ribs 133, allowing the oil to be gathered near to the straight line to flow it from the inlet 111a to the outlet 121a.

### Third Embodiment

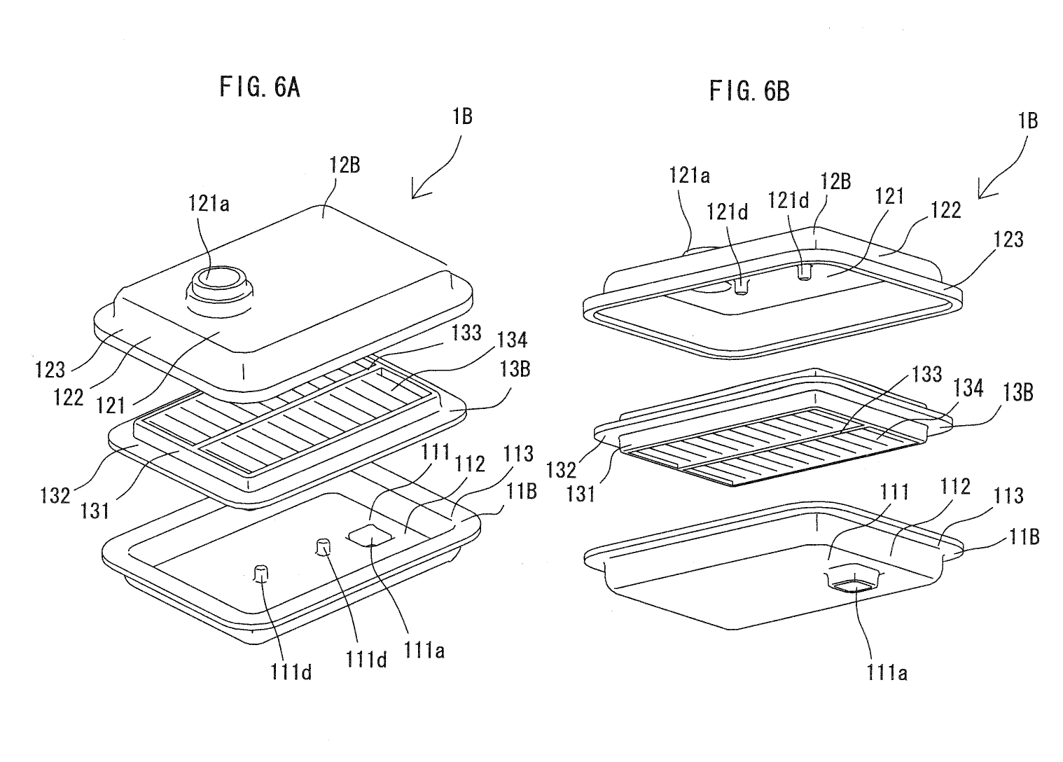

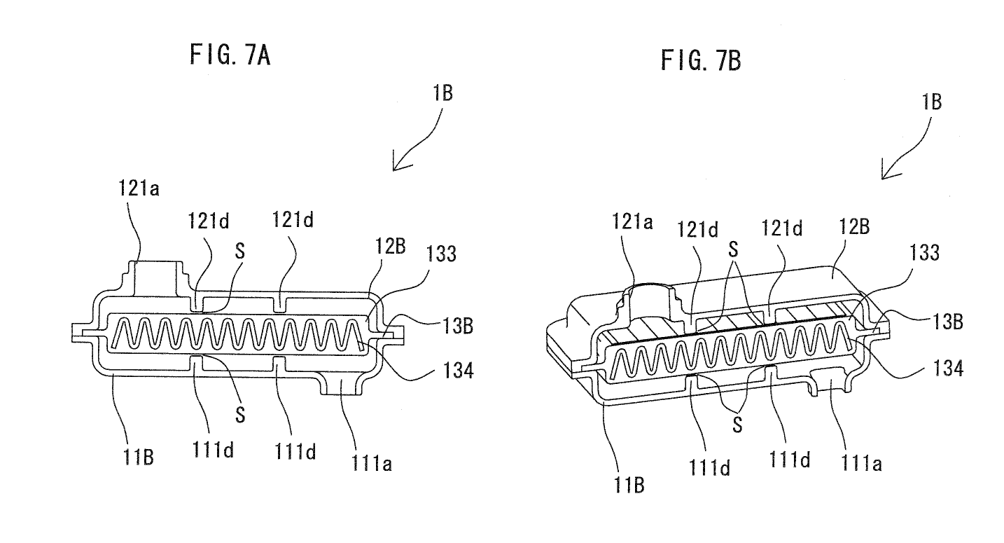

With reference to FIGS. 6A, 6B, 7A and 7B, an oil filter 1B is described.

A case 11B includes bar-shaped support protrusions 111d as support members extending upward from the bottom wall 111 and longitudinally arranged. A cover 12B includes bar-shaped support protrusions 121d as support members extending downward from the top wall 121 and longitudinally arranged.

The support protrusions 111d, 121d and the ribs 133 are arranged in plane view on the straight line connecting the inlet 111a and the outlet 121a. Thus, the support protrusions 111d and the ribs 133 are coincident with each other with regard to the transverse positions. The ribs 133 and the support protrusions 111d are opposed to each other with spaces S between them 133, 111d. The support protrusions 121d and the ribs 133 are coincident with each other with regard to the transverse positions. The ribs 133 and the support protrusions 121d are opposed to each other with spaces S between them 133, 121d.

According to the above oil filter 1B, during the welding of the case 11B and the cover 12B, the support protrusions 111d, 121d are opposed to the rib 133 with the spaces S between them, which prevents a foreign matter from being caused during the welding.

The spaces S permit passing of the oil through them, thus ensuring a flow passage of the oil.

When a negative pressure is caused in the case, the support protrusions 111d, 121d abut against the ribs 133 so as to support the bottom wall 111 and the top wall 121 of the cover 12B, respectively.

### Fourth Embodiment

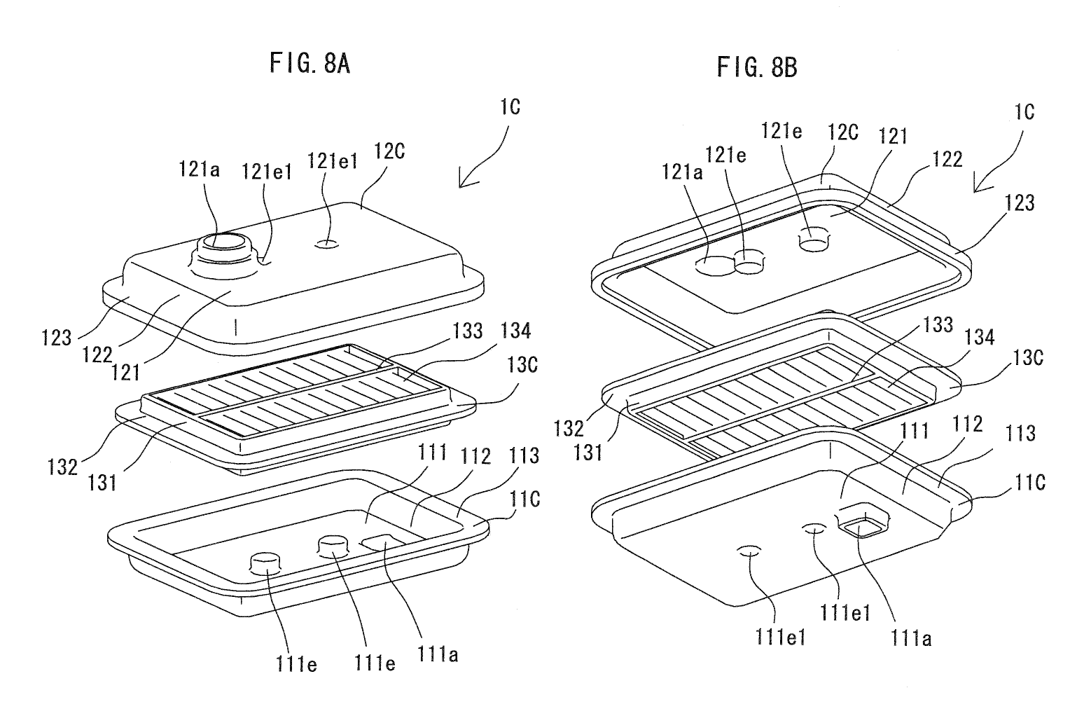

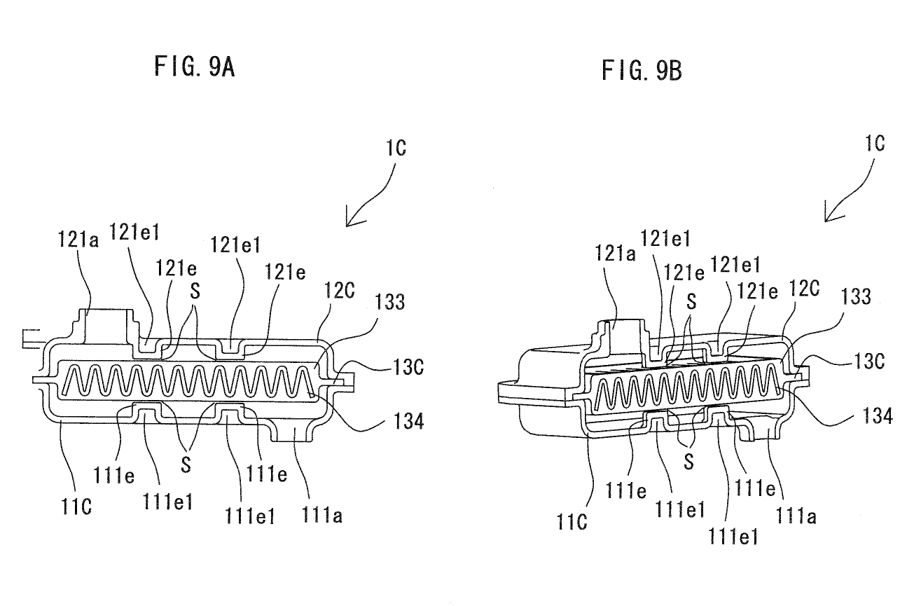

With reference to FIGS. 8A, 8B, 9A and 9B, an oil filter 1C is described.

A case 11C includes a support cylinders 111e as support members extending upward from the bottom wall 111 and longitudinally arranged. The support cylinders 111e have recesses 111e1 recessed from the surface of the bottom wall 111.

The cover 12C includes support cylinders 121e extending downward from the top wall 121 and longitudinally arranged. The support cylinders 121e have recesses 121e1 recessed from the surface of the top wall 121.

The support cylinders 111e, 121e and the ribs 133 are arranged in plane view on the straight line connecting the inlet 111a and the outlet 121a. Thus, the support cylinders 111e and the ribs 133 are coincident with each other with regard to the transverse positions. The support cylinders 111e and the ribs 133 are opposed to each other with spaces S between them 111e, 133. The support cylinders 121e and the ribs 133 are coincident with each other with regard to the transverse positions. The support cylinders 121e and the ribs 133 are opposed to each other with spaces S between them 121e, 133.

According to the above oil filter 1C, during the welding of the case 11C and the cover 12C, the support cylinders 111e, 121e are opposed to the ribs 133 with the spaces S between them, which prevents a foreign matter from being caused during the welding.

The spaces S permit passing of the oil through them, ensuring a flow passage of the oil.

When a negative pressure is caused in the case, the support cylinders 111d, 121d abut against the ribs 133 so as to support the bottom wall 111 of the case 11C and the top wall 121 of the cover 12c, respectively.

The recesses 111e1, 121e1 of the support cylinders 111e, 121e are recessed from the bottom wall 11 of the case 11C and the top wall 121 of the cover 12C, respectively, which prevents the case or the cover from being contacted with other members.

### Fifth Embodiment

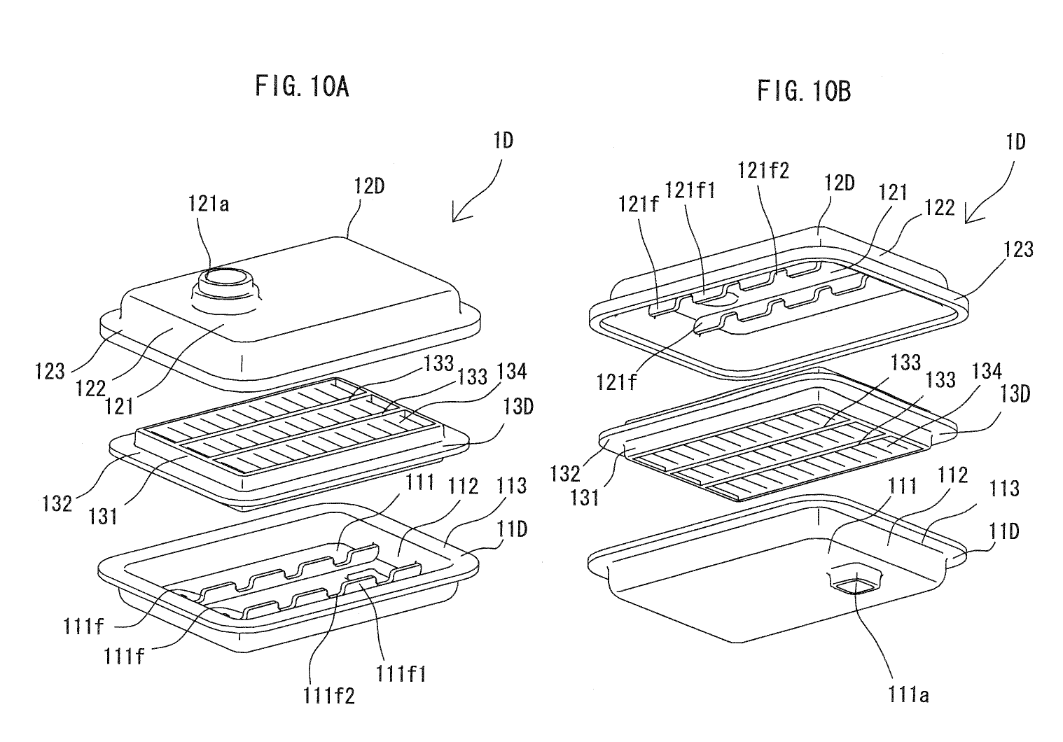

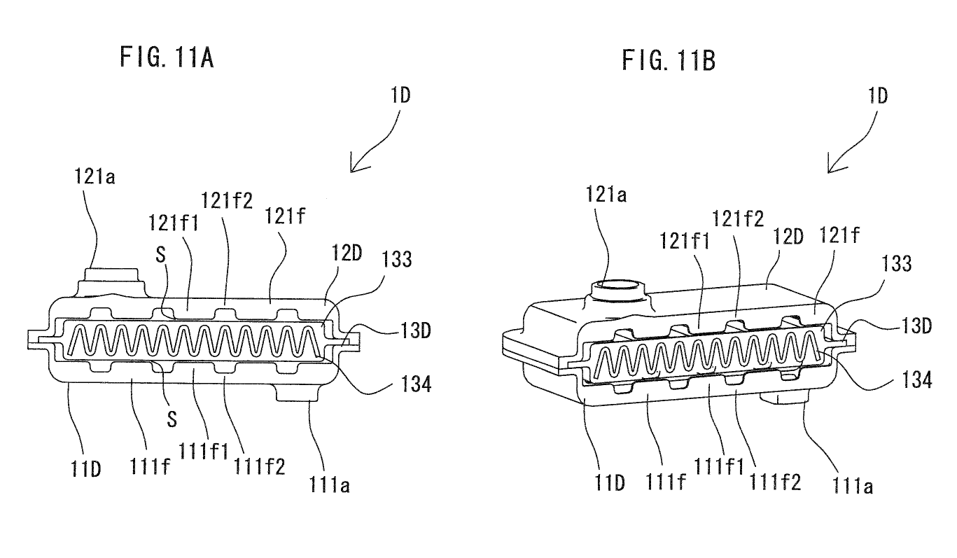

With reference to FIGS. 10A, 10B, 11A and 11B, an oil filter 1D is described.

A case 11D includes supports 111f as support members arranged on the bottom wall 111 in two rows and longitudinally extending. Each support 111f includes support walls 111f1 arranged at a certain interval, and connection walls 111f2 extending between the support walls 111f1. A cover 12D includes supports 112f as support members arranged on the top wall 121 in two rows and longitudinally extending. Each supports 121f includes support walls 121f1 arranged at a certain interval, and connection walls 121f2 extending between the support walls 121f1.

Here, the supports 111f, 121f and the ribs 133 are arranged in plane view parallel to the straight line connecting the inlet 111a and the outlet 121a. Thus, the support walls 111f1 of the case 11D and the ribs 133 are coincident with each other with regard to the transverse positions. The support walls 111f1 of the case 11D are opposed to the ribs 133 with spaces S between them 111f1, 133. The support walls 121f1 of the cover 12D and the ribs 133 are coincident with each other with regard to the transverse positions. The support walls 121f1 of the cover 12D are opposed to the ribs 133 with spaces S between them 121f1, 133.

According to the above oil filter ID, during the welding of the case 11D and the cover 12D, the support walls 111f1, 121f1 are opposed to the ribs 133 with the spaces S between them, which prevents a foreign matter from being caused during the welding.

The spaces S permits passing of the oil through them, ensuring a flow passage of the oil.

When a negative pressure is caused in the case, the support walls 111f1, 121f1 abut against the ribs 133 so as to support the bottom wall 111 of the case 11D and the top wall 121 of the cover 12D, respectively.

### Sixth Embodiment

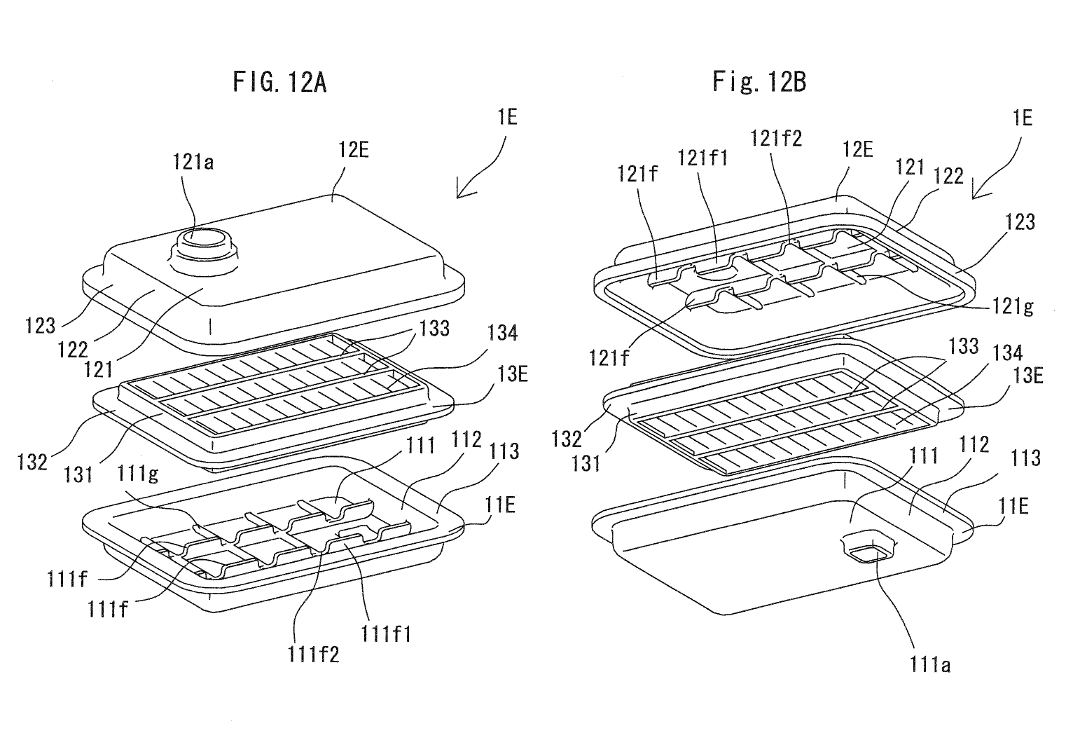

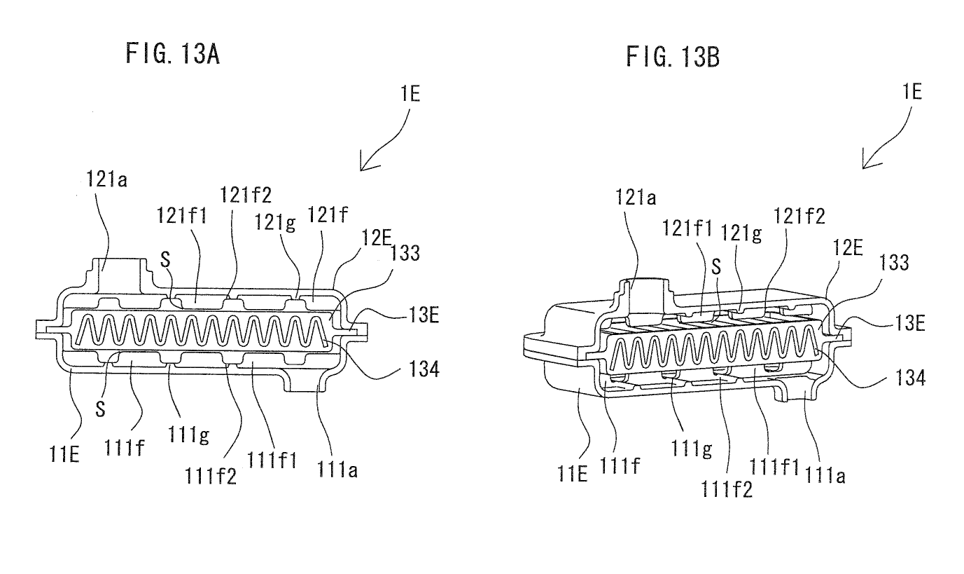

With reference to FIGS. 12A, 12B, 13A and 13B, an oil filter 1E is described.

A case 11E includes supports 111f as support members arranged on the bottom wall 111 in two rows and longitudinally extending. The supports 111f include support walls 111f1 arranged at a certain interval, and connection walls 111f2 extending between the support walls 111f1. The case 11E includes ribs 111g located on the bottom wall 111 and extending transversely to cross the connection walls 111f2. The cover 12E includes supports 121f as support members arranged on the bottom wall 111 in two rows and longitudinally extending. The supports 121f include support walls 121f1 arranged at a certain interval and connection walls 121f2 extending between the support walls 121f1. The cover 12E includes ribs 121g located on the top wall 121 and extending transversely to cross the connection walls 121f2.

The supports 111f, 121f and the rib 133 are arranged in plane view parallel to the straight line connecting the inlet 111a and the outlet 121a. Thus, the support walls 111f1 of the case 11E and ribs 133 are coincident with each other with regard to the transverse positions. The support walls 111f1 of the case 11E are opposed to the ribs 133 with spaces S between them 111f1, 133. The support walls 121f1 of the cover 12E and ribs 133 are coincident with each other with regard to the transverse positions. The support walls 121f1 of the cover 12E are opposed to the ribs 133 with spaces S between them 121f1, 133.

According to the above oil filter 1E, during the welding the case 11E and the cover 12E, the support walls 111f1, 121f1 are opposed to the ribs 133 with the spaces S between them, which eliminates the cause of a foreign matter during the welding.

The spaces S permit passing of the oil through them, ensuring a flow passage of the oil.

When a negative pressure is caused in the case, the support walls 111f1, 121f1 abut against the ribs 133 so as to support the bottom wall 111 of the case 11E and the top wall 121 of the cover 12E, respectively.

The ribs 111g, 121g support the case 11E and the cover 12E deformed under a negative pressure.

### Seventh Embodiment

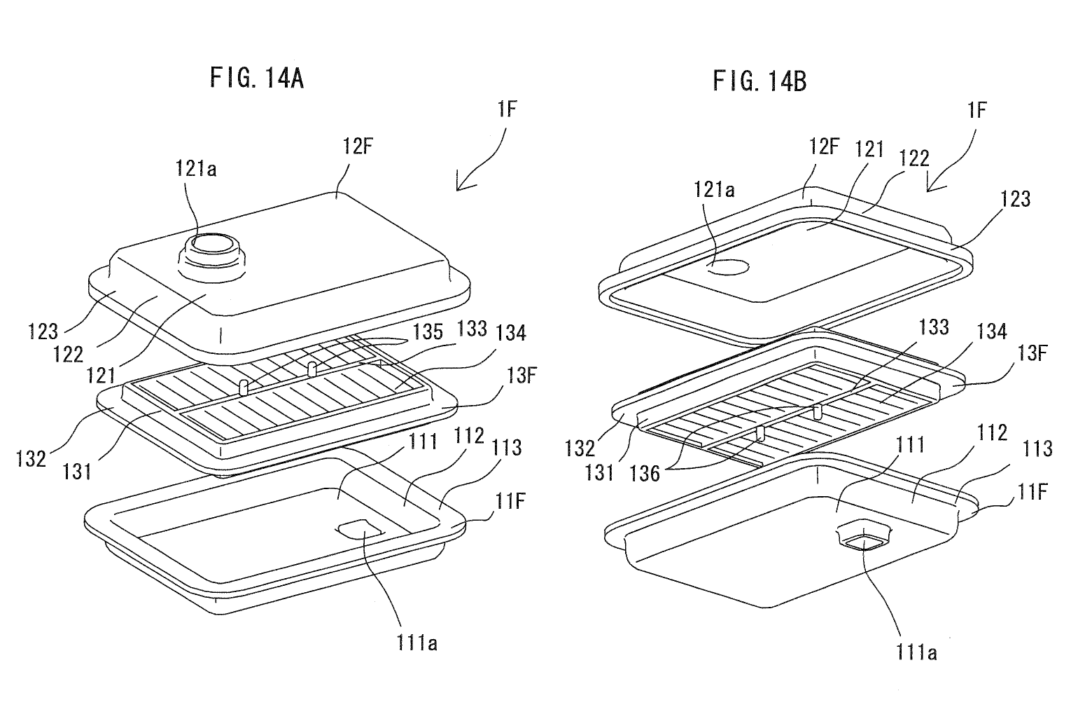

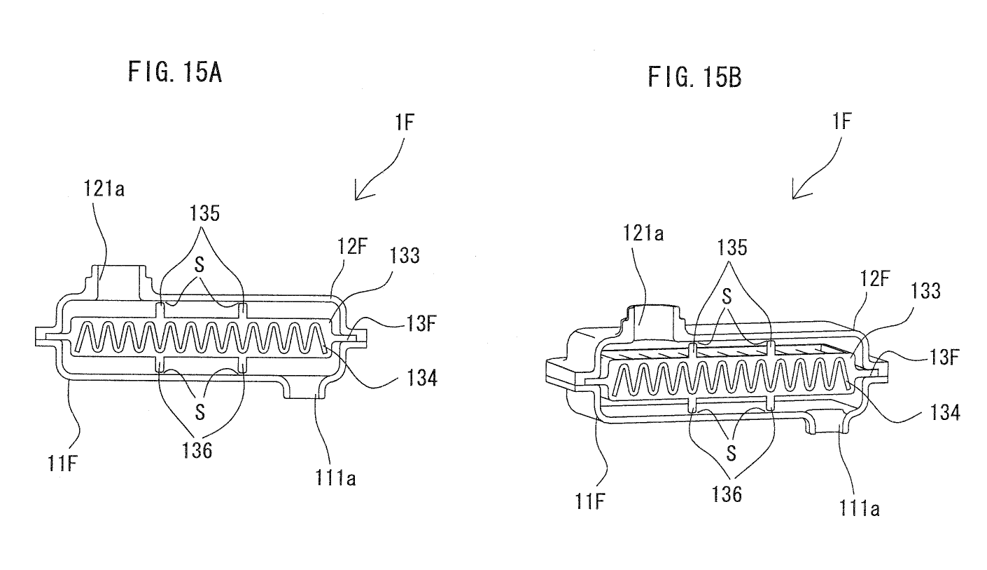

With reference to FIGS. 14A, 14B, 15A and 15B, an oil filter 1F is described.

A rib 133 has bar-shaped upper and lower protrusions 135, 136 as support members located on the upper and lower ends and longitudinally arranged.

Here, the upper and lower protrusions 135, 136 are arranged in plane view on the straight line connecting the inlet 111a and the outlet 121a. The upper protrusions 135 are opposed to the top wall 121 of the cover 12F with spaces S between them 135, 121. The lower protrusions 136 are opposed to the bottom wall 111 of the case 111F with spaces S between them 136, 111.

According to the oil filter 1F, during the welding of the case 11F and the cover 12F, the upper and lower protrusions 135, 136 are opposed to the top and bottom walls 121, 111 with the spaces S between them, respectively, which eliminates the cause of a foreign matter during the welding.

The spaces S permit passing of an oil through them, ensuring a flow passage of the oil.

When a negative pressure is caused in the case, the upper and lower protrusions 135, 136 abut against the top wall 121 of the cover 12F and the bottom wall 111 of the case 11F so as to support the cover 12F and the case 11F, respectively.

### Eighth Embodiment

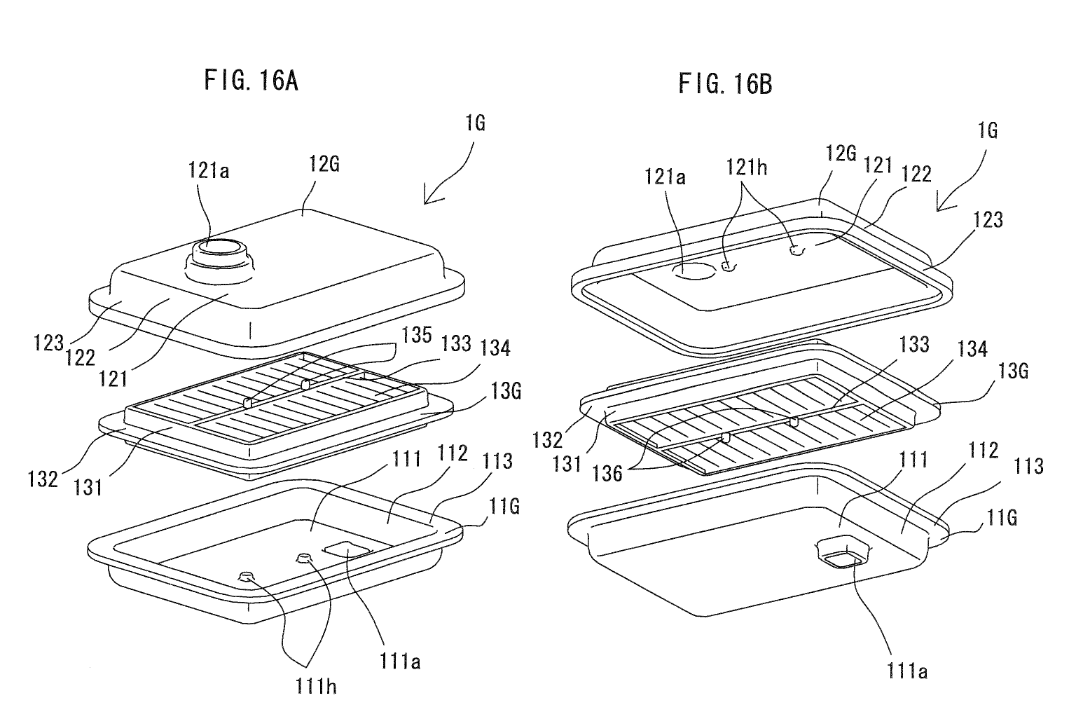

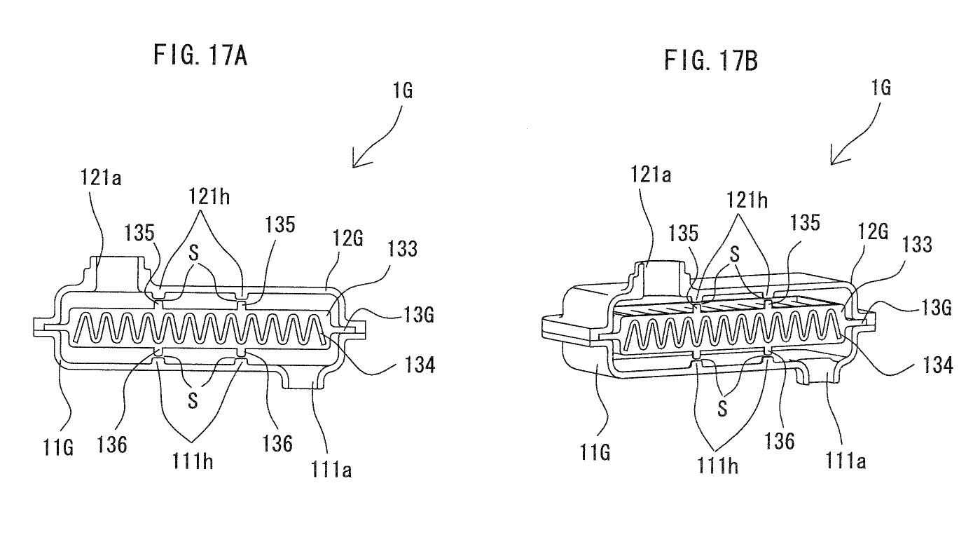

With reference to FIGS. 16A, 16B, 17A and 17B, an oil filter 1G is described.

The rib 133 has bar-shaped upper and lower protrusions 135, 136 as support members located on the upper and lower ends and longitudinally arranged. The case 11G has cylinders 111h as support members located on the bottom wall 111 and longitudinally arranged. Each of the cylinders 111h is located to be coincident with the corresponding lower protrusion 136. The cover 12G has cylinders 121h as support members located on the top wall 121 and longitudinally arranged. Each of the cylinders 121h is located to be coincident with the corresponding upper protrusion 135.

The upper and lower protrusions 135, 136 are arranged in plane view on the straight line connecting the inlet 111a and the outlet 121a. The upper protrusions 135 are opposed to the cylinders 121h with a certain space S between them 135, 121h. The lower protrusions 136 are opposed to the cylinders 111h with a certain space S between them 136, 111h.

According to the oil filter 1G, during the welding of the case 11G and the cover 12G, the upper and lower protrusions 135 and 136 are opposed to the cylinders 121h, 111h with the spaces S between them, respectively, which eliminates the cause of a foreign matter during the welding.

The spaces S permit passing of the oil through them, ensuring a flow passage of the oil.

When a negative pressure is caused in the case, the cylinders 121h, 111h abut against the upper and lower protrusions 135, 136, respectively, to support the top wall 121 of the cover 12G and the bottom wall 111 of the case 11G.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A fluid filter comprising:
a filter media for fluid to pass therethough;
a filter element including a holding member for holding the filter media;
a filter case housing the filter element, having a fluid inlet positioned on a side relative to the filter element, and having a fluid outlet positioned on another side relative to the filter element, and;
a support member extending between the holding member and the filter case,
the support member being opposed to one member of the filter case and the holding member with a space between the support member and said one member.

2. The fluid filter according to claim 1,
wherein the support member extends from the filter case toward the holding member.

3. The fluid filter according to claim 1,
wherein the support member extends from the holding member toward the filter case.
